(19) United States
(12) Patent Application Publication
(10) Pub. No.: US 2016/0178099 A1
(43) Pub. Date: Jun. 23, 2016

(54) SWIVEL JOINT FOR PIPES

(71) Applicant: PLAINSMAN MFG. INC., Edmonton (CA)

(72) Inventors: Mark Geusebroek, St. Albert (CA); Shane McAssey, Ardrossan (CA); Ken Salomons, Edmonton (CA)

(21) Appl. No.: 14/578,001

(22) Filed: Dec. 19, 2014

(51) Int. Cl. F16L 27/08; F16L 21/04; F16L 21/03

(52) U.S. Cl. CPC F16L 27/0853; F16L 21/03; F16L 21/04

(57) ABSTRACT

The swivel joint comprises a hollow ball and socket arrangement allowing for rotation and misalignment as well as the conveyance of fluid through the hollow elements of the swivel joint. Sealing of the ball in the socket is accomplished by a sealing element packed between the ball and the socket. This sealing element is energized by a biasing element or plurality of biasing elements. The energization of the sealing element via biasing elements allows for retained seal energization through changes to the geometry of the swivel joint due to thermal expansion and other factors. Furthermore, the sealing element is energized independently of retaining the ball in the central location of the socket. The ball is retained by a ball retaining collar on the front of the swivel joint.

### FIELD

Swivel joints for pipes.

### BACKGROUND

A swivel joint comprises a hollow ball and socket arrangement allowing for rotation and misalignment as well as the conveyance of fluid through the hollow elements of the swivel joint. Sealing of the ball in the socket is accomplished by a sealing element packed between the ball and the socket.

### SUMMARY

Novel swivel joints are disclosed with energized packing to assist in providing effective sealing of the joint. In an embodiment, there is disclosed a swivel joint comprising a hollow ball having a front side and rear side, a socket comprising a housing and ball retaining collar, the ball retaining collar bearing up against the hollow ball on the front side of the hollow ball and the housing bearing up against the rear side of the hollow ball, front pins securing the ball retaining collar to the housing with an annular receiving space between the ball retaining collar and the housing, the annular receiving space having a packing receiving portion, a packing ring within the annular receiving space, packing in the packing receiving portion, the packing contacting the hollow ball and being pressed between the packing ring and the housing; and a packing energizer connected between the packing ring and ball retaining collar to press the packing between the packing ring, hollow ball, and the housing. Various forms of energizer are disclosed.

In a further embodiment, there is disclosed a swivel joint comprising a hollow ball having a front side and rear side, a socket comprising a housing and ball retaining collar, the ball retaining collar bearing up against the hollow ball on the front side of the hollow ball and the housing bearing up against the rear side of the hollow ball, front pins securing the ball retaining collar to the housing with an annular receiving space between the ball retaining collar and the housing, the annular receiving space having a packing receiving portion, packing in the packing receiving portion, the packing contacting the hollow ball and being pressed between the packing ring and the housing; and a packing energizer between the packing and either or both of the ball retaining collar and housing to press the packing between the ball retaining collar, hollow ball, and the housing.

In various embodiments, there may be provided one or more of the following features: the packing energizer comprises rear pins secured to the packing ring and extending through the housing with a biasing element acting on the rear pins and the housing to press the packing ring against the packing; the biasing element comprises one or more springs; the biasing element comprises a Belleville spring arrangement; the annular receiving space is larger than the packing ring to accommodate expansion and contraction of the elements during heat cycles; the hollow ball has a bore, the bore has a central axis, and the packing comprises a stack of packing extending parallel to the central axis; and the hollow ball has a bore, the bore has a central axis, and the packing contacts a part of the hollow ball where a tangent to the hollow ball is parallel to the central axis.

### BRIEF DESCRIPTION OF THE DRAWINGS

There will be described embodiments of swivel joints with energized packing with reference to the Figures in which like reference characters denote like elements and in which:

FIG. 1 shows a first embodiment of a swivel joint with energized packing;

FIG. 2 shows a second embodiment of a swivel joint with energized packing;

FIG. 3 shows a third embodiment of a swivel joint with energized packing;

FIG. 4 shows a fourth embodiment of a swivel joint with energized packing;

FIG. 5 shows a fifth embodiment of a swivel joint with energized packing;

FIG. 6 shows a sixth embodiment of a swivel joint with energized packing;

FIG. 7 shows a seventh embodiment of a swivel joint with energized packing;

FIG. 8 shows an eighth embodiment of a swivel joint with energized packing;

FIG. 9 shows a ninth embodiment of a swivel joint with energized packing.

### DETAILED DESCRIPTION

The swivel joint comprises a hollow ball and socket arrangement allowing for rotation and misalignment as well as the conveyance of fluid through the hollow elements of the swivel joint. Sealing of the ball in the socket is accomplished by a sealing element packed between the ball and the socket. This sealing element is energized by a biasing element or plurality of biasing elements. The energization of the sealing element via biasing elements allows for retained seal energization through changes to the geometry of the swivel joint due to thermal expansion and other factors. Furthermore, the sealing element is energized independently of retaining the ball in the central location of the socket. The ball is retained by a ball retaining collar on the front of the swivel joint.

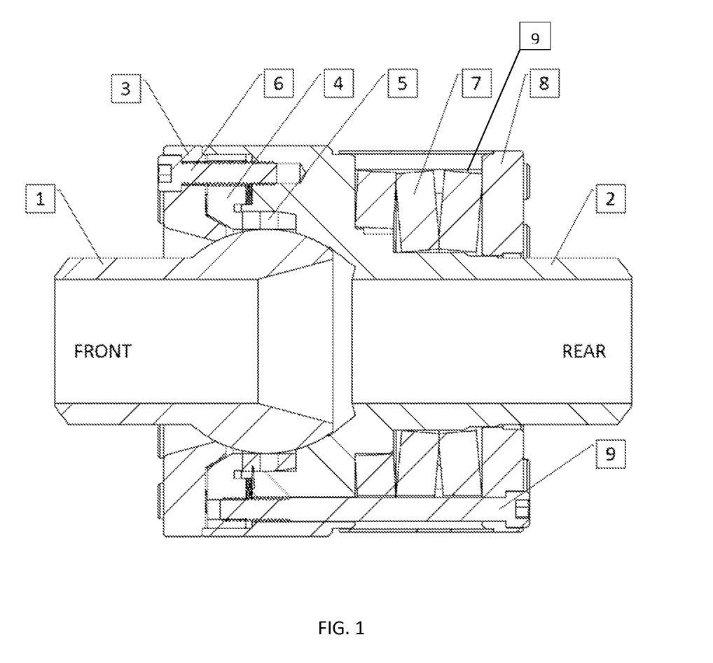

Referring to FIG. 1, there is shown a swivel joint. In the embodiment shown, the swivel joint includes a hollow ball 1 having a front side left in the figure and rear side right in the figure. The hollow ball 1 is confined within a socket comprising a housing 2 and ball retaining collar 3. The ball retaining collar 3 bears up against the hollow ball 1 on the front side of the hollow ball 1 and the housing 2 bears up against the rear side of the hollow ball 1. Front pins 6 secure the ball retaining collar 3 to the housing 2 with an annular receiving space between the ball retaining collar 3 and housing 2. The pins 6 are distributed around the circumference of the housing 2. The annular receiving space has a packing receiving portion. A packing ring 4 is disposed within the annular receiving space. Packing 5 is disposed within the packing receiving portion. Packing 5 contacts the hollow ball 1 and is pressed between the packing ring 4 and housing 2. A packing energizer comprising packing ring 4, a biasing element 7, and rear pins 9 is connected between the packing ring 4 and housing 2 to press the packing 5 between the packing ring 4, hollow ball 1, and the housing 2.

Various forms of packing energizer may be used. In one embodiment, shown in FIG. 1, the packing energizer comprises rear pins 9 secured to the packing ring 4 and extending through the housing 2 with a biasing element 7 (here, Belleville springs) acting on the rear pins 9 and housing 2 to press the packing ring 4 against the packing 5. The biasing element may comprise one or more springs. The annular receiving space is preferably larger than the packing ring to accommodate expansion and contraction of the elements during heat cycles. In an embodiment, the hollow ball has a bore, the bore has a central axis, and the packing comprises a stack of packing extending parallel to the central axis. In an embodiment, the hollow ball has a bore, the bore has a central axis, and the packing contacts a part of the hollow ball where a tangent to the hollow ball is parallel to the central axis.

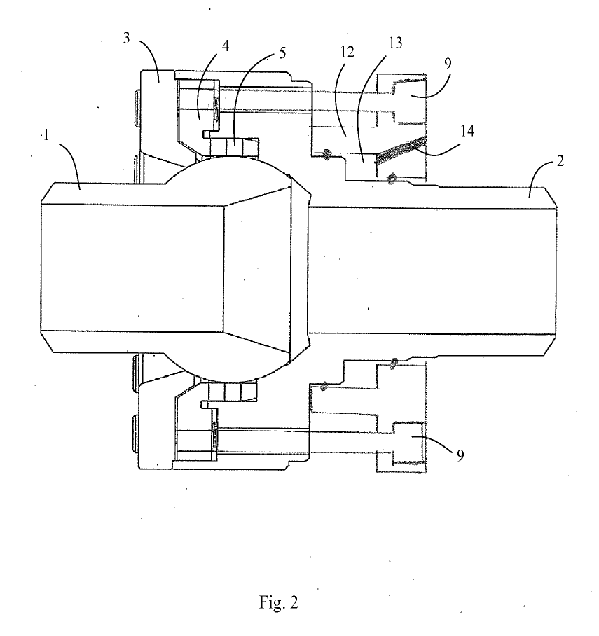

In another embodiment, shown in FIG. 2, a cylinder ring 12 between packing ring pins 9 and the housing 2 acts on the packing ring pins to energize the packing 5. An external pressure source is applied through pressure port 14 to the pressure chamber 13. The external pressure forces the pressure chamber away from the housing 2 towards the rear of the assembly. The movement of the pressure chamber away from the housing acts on the cylinder ring 12 to force the cylinder ring 12 towards the rear of the assembly, and the retention of the cylinder ring by the packing ring pins 9 enables constant energization of the packing 5.

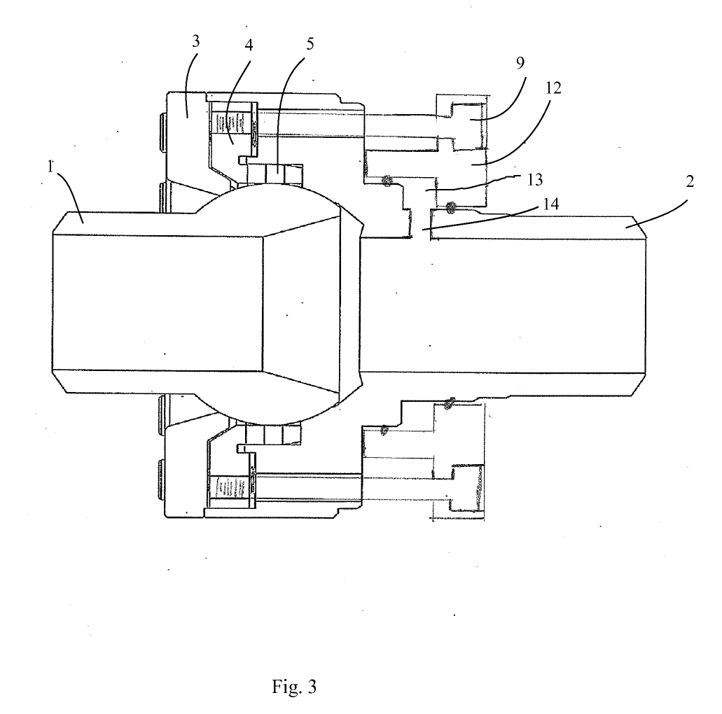

In another embodiment, referring to FIG. 3, cylinder ring 12 acts between the packing ring pins 9 and the housing 2. Internal line pressure is applied to the pressure chamber 13 through pressure port 14 formed in the housing 2. The internal line pressure forces the pressure chamber away from the housing 2 towards the rear of the assembly. The movement of the pressure chamber away from the housing acts on the cylinder ring 12 to force the cylinder ring 12 towards the rear of the assembly, and the retention of the cylinder ring by the packing ring pins 9 enables energization of the packing 5. Packing 5 is only energized when there is line pressure present in the internal bore.

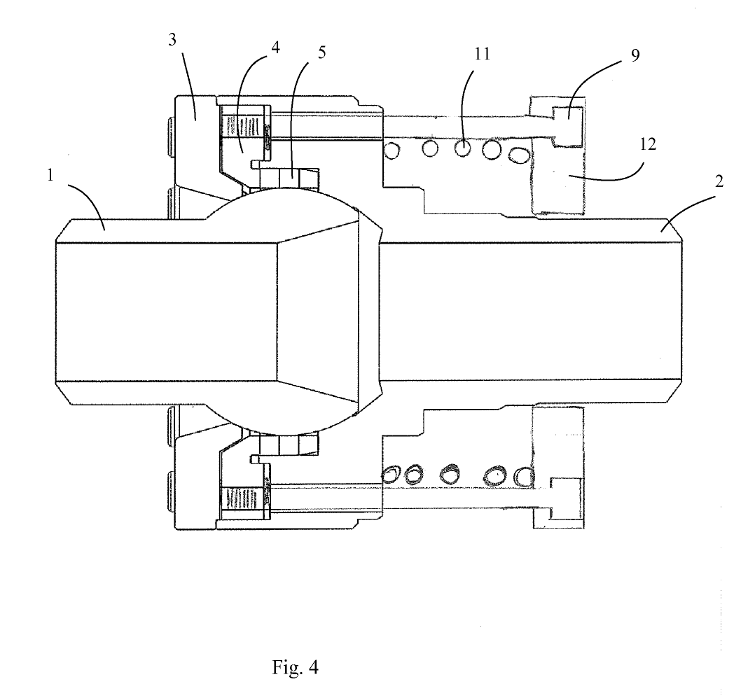

Referring to FIG. 4, a bias element 11 energizing the press ring 12 that extends around the housing 2 and is a large coil spring, instead of an arrangement of Belleville style spring elements as shown in FIG. 1.

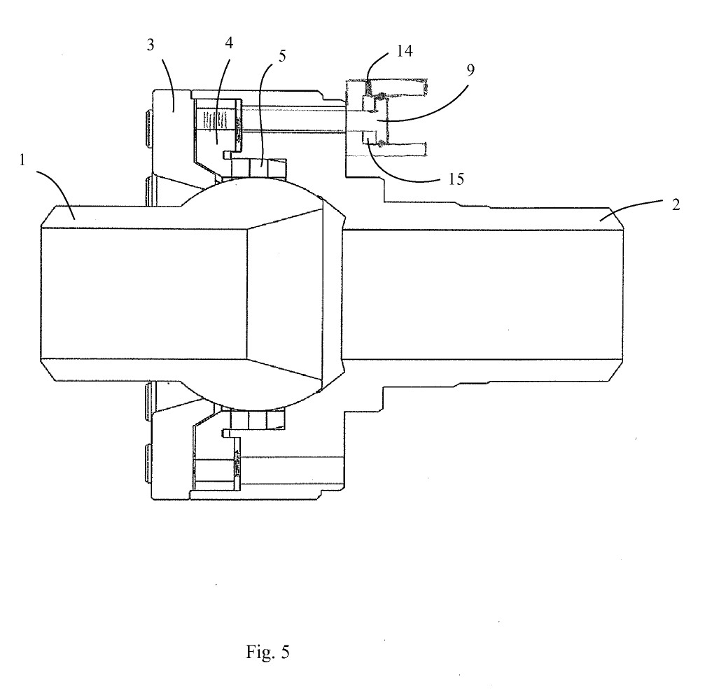

In another embodiment, shown in FIG. 5, each packing ring pin 9 is replaced or activated by a pressure cylinder 15. The application of either line pressure or hydraulic fluid pressure to each of the pressure cylinders 15 replacing or activating packing ring pins 9 enables energization of the packing 5. Hydraulic fluid pressure may be applied through pressure port 14. The force of the pressure within the pressure cylinder 15 forces the packing ring pins 9 away from housing 2 towards the rear of the assembly to enable energization of the packing 5.

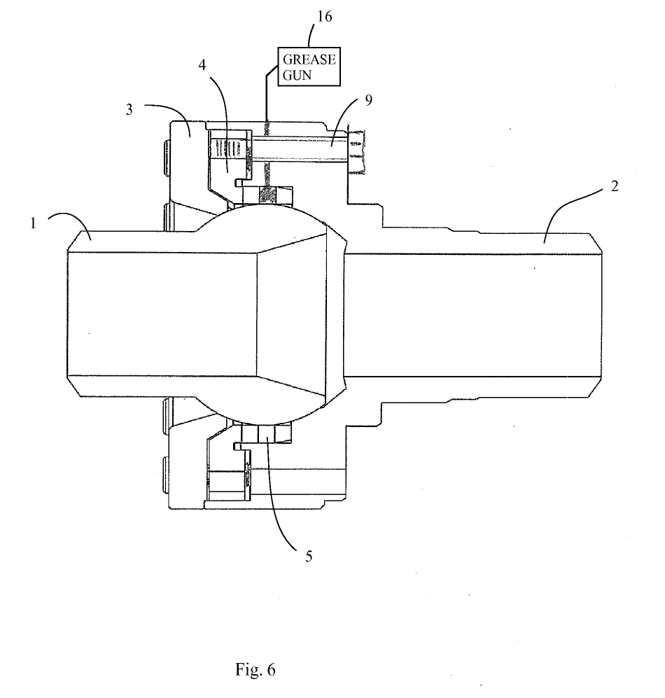

In another embodiment, shown in FIG. 6, grease is applied by a grease accumulator or grease gun 16 through rows of packing 5. The injected grease forms a pressure chamber between sealed packing elements 5, which energizes the packing 5. The grease is applied with pressure from an external grease accumulator 16, which allows for maintained grease pressure through changes to the swivel and packing geometry.

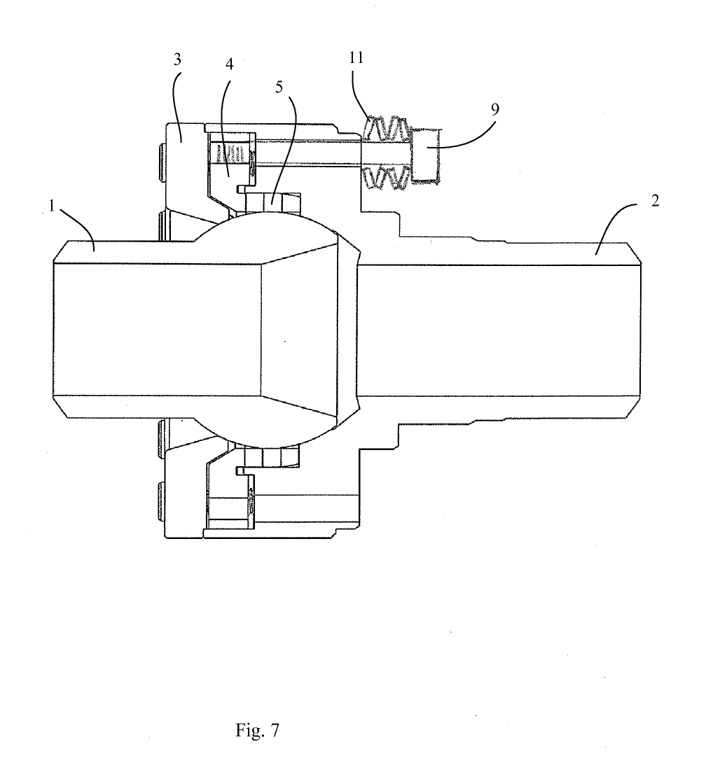

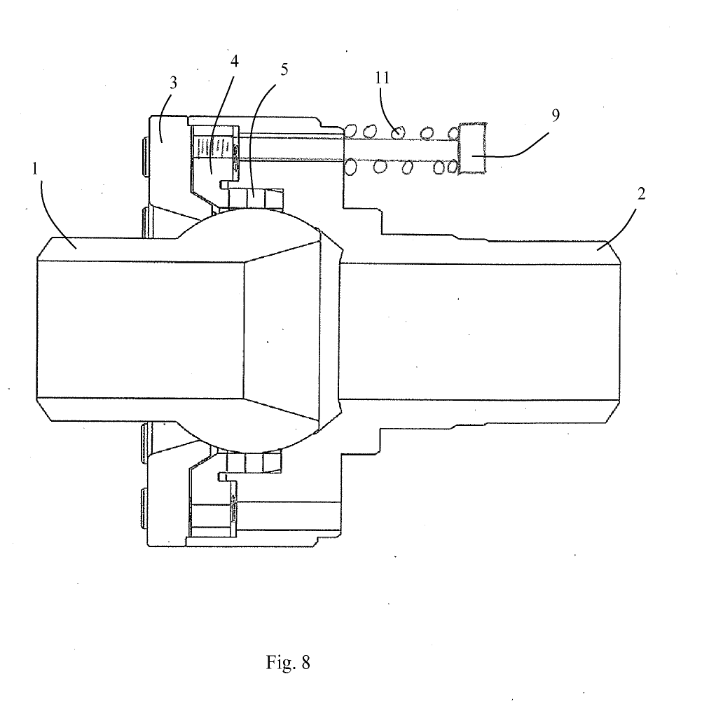

In another embodiment, shown in FIGS. 7 and 8, each packing ring pin 9 is energized by an arrangement of biasing elements 11. Biasing elements 11 apply pressure against packing ring pins 9 and force packing ring pins 9 away from the housing 2 towards the rear of the assembly. The movement of the packing ring pins 9 enables energizing of the packing 5. In FIG. 7, biasing elements 11 are Belleville spring elements, which may be stacked, which allows for maintained energization of the packing 5. In FIG. 8, each packing ring pin 9 is energized by a biasing element 11 which is a coil spring, which allows for maintained energization of the packing 5.

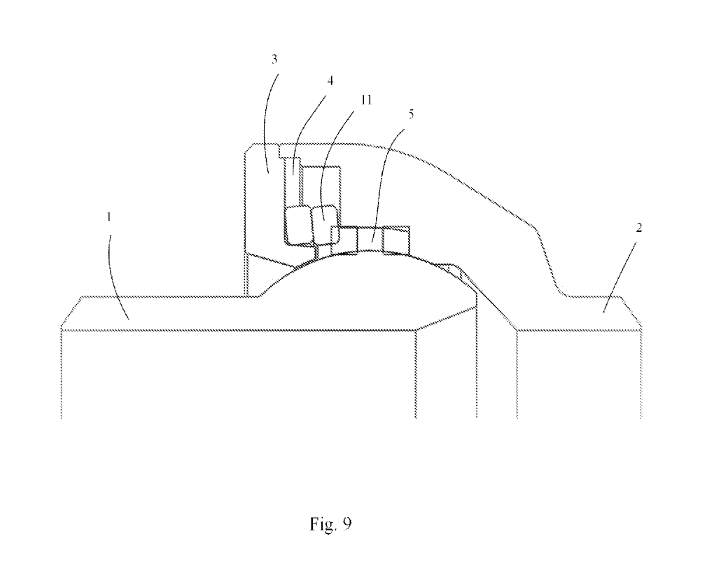

In another design for the energization of the packing, shown in FIG. 9, a biasing element 11, which may be Belleville washers, is positioned in the front of the assembly and acts between the packing ring 9 and the ball retaining ring 3. Packing energization is maintained by the spring energy stored in the biasing element 11. The biasing element 11 may be located on either or both sides of the packing 5 within the packing receiving portion.

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

What is claimed is:

1. A swivel joint, comprising:
a hollow ball having a front side and rear side;
a socket comprising a housing and ball retaining collar, the ball retaining collar bearing up against the hollow ball on the front side of the hollow ball and the housing bearing up against the rear side of the hollow ball;
front pins securing the ball retaining collar to the housing with an annular receiving space between the ball retaining collar and the housing, the annular receiving space having a packing receiving portion;
a packing ring within the annular receiving space;
packing in the packing receiving portion, the packing contacting the hollow ball and being pressed between the packing ring and the housing; and
a packing energizer connected between the packing ring and ball retaining collar to press the packing between the packing ring, hollow ball, and the housing.

2. The swivel joint of claim 1 in which the packing energizer comprises rear pins secured to the packing ring and extending through the housing with a biasing element acting on the rear pins and the housing to press the packing ring against the packing.

3. The swivel joint of claim 2 in which the biasing element comprises one or more springs.

4. The swivel joint of claim 3 in which the biasing element comprises a Belleville spring arrangement.

5. The swivel joint of claim 2 in which the hollow ball has a bore, the bore has a central axis, and the packing comprises a stack of packing extending parallel to the central axis.

6. The swivel joint of claim 1 in which the biasing element comprises one or more springs.

7. The swivel joint of claim 6 in which the biasing element comprises a Belleville spring arrangement.

8. The swivel joint of claim 1 in which the annular receiving space is larger than the packing ring to accommodate expansion and contraction of the elements during heat cycles.

9. The swivel joint of claim 8 in which the hollow ball has a bore, the bore has a central axis, and the packing comprises a stack of packing extending parallel to the central axis.

10. The swivel joint of claim 8 in which the biasing element comprises one or more springs.

11. The swivel joint of claim 10 in which the biasing element comprises a Belleville spring arrangement.

12. The swivel joint of claim 1 in which the hollow ball has a bore, the bore has a central axis, and the packing comprises a stack of packing extending parallel to the central axis.

13. The swivel joint of claim 12 in which the biasing element comprises one or more springs.

14. The swivel joint of claim 13 in which the biasing element comprises a Belleville spring arrangement.

15. The swivel joint of claim 1 in which the hollow ball has a bore, the bore has a central axis, and the packing contacts a part of the hollow ball where a tangent to the hollow ball is parallel to the central axis.

16. The swivel joint of claim 15 in which the annular receiving space is larger than the packing ring to accommodate expansion and contraction of the elements during heat cycles.

17. The swivel joint of claim 16 in which the hollow ball has a bore, the bore has a central axis, and the packing comprises a stack of packing extending parallel to the central axis.

18. The swivel joint of claim 15 in which the biasing element comprises one or more springs.

19. The swivel joint of claim 18 in which the biasing element comprises a Belleville spring arrangement.

20. A swivel joint, comprising:
a hollow ball having a front side and rear side;
a socket comprising a housing and ball retaining collar, the ball retaining collar bearing up against the hollow ball on the front side of the hollow ball and the housing bearing up against the rear side of the hollow ball;
front pins securing the ball retaining collar to the housing with an annular receiving space between the ball retaining collar and the housing, the annular receiving space having a packing receiving portion;
packing in the packing receiving portion, the packing contacting the hollow ball and being pressed between the packing ring and the housing; and
a packing energizer between the packing and either or both of the ball retaining collar and housing to press the packing between the ball retaining collar, hollow ball, and the housing.
